(19) United States
(12) Patent Application Publication
(10) Pub. No.: US 2026/0257411 A1
(43) Pub. Date: Sep. 3, 2026

(54) Device and Method for Producing a Tubular Film

(71) Applicant: Windmöller & Hölscher KG, Lengerich (DE)

(72) Inventors: Ingo Hehmann, Lengerich (DE); Marco Ventker-Stegemann, Lengerich (DE); Michel Bembenek, Lengerich (DE)

(21) Appl. No.: 18/838,454

(22) PCT Filed: Feb. 16, 2023
(86) PCT No.: PCT/EP2023/053915

§ 371 Date: Aug. 14, 2024

(30) Foreign Application Priority Data
Feb. 16, 2022 (DE) 10 2022 201 613.0

(51) Int. Cl. B29C 48/10; B29C 48/88; B29C 48/885; B29C 48/92; B29L 23/00

(52) U.S. Cl. CPC B29C 48/10; B29C 48/885; B29C 48/912; B29C 48/92; B29C 2948/92123; B29C 2948/92209; B29L 2023/001

(57) ABSTRACT

The invention describes a device for producing a tubular film comprising
an outlet nozzle of a die from which a plastic melt can be guided out in a transport direction and can be formed into a tubular film;
a cooling means arranged downstream of the outlet nozzle in the transport direction;
at least one detection means for observing the tubular film in an observation area.

The observation area is arranged between the outlet nozzle and the cooling means.

The invention describes a device for producing a tubular film according to Claim 1 and a corresponding method according to Claim 8.

In a blow film line, which represents a device for producing a tubular film, one or more plastic melts are produced from plastic granulates in one or more extruders. The plastic melt or the plastic melts are distributed in a die in an annular manner and are passed out of the die through an outlet nozzle, thereby forming a tubular film. The tubular film created in this way can be drawn off via a draw-off, which comprises a pair of rollers with at least one driven roller. Downstream of the outlet nozzle, as viewed in the transport direction, the blown film is generally cooled on the inside and/or outside by means of cooling means, so that the plastic melt solidifies. In particular the external cooling means may extend annularly around the tubular film. Also know are detection means with which the area in which the plastic melt solidifies can be determined, so that so that conclusions can be drawn about the cooling behavior of the tubular film.

In some generic devices, the outlet nozzle and the cooling means, in particular the external cooling means, are spaced apart from one another. Said distance is often variably adjustable. In said area between the outlet nozzle and the cooling means, the still very hot melt is moved freely without any guiding mechanism. This can quickly lead to deformation of the melt, which often results in melt breakage. A melt or tubular film breakage leads to standstill times of the blow film line because the tubular film must be manually transported from the outlet nozzle to the draw-off. Consistent production must then be achieved again.

The object is thus to propose a device and a method with which melt breakages can be avoided.

The above object is accomplished by a device having the features of Claim 1 and with a method having the features of Claim 8. Further features and details of the invention derive from the dependent claims, the description and the figures. Features and details which are described in the context of the method according to the invention naturally also apply in the context of the blow film line according to the invention and vice versa, respectively, so that reference is or can always be made to the individual aspects of the invention reciprocally with respect to the disclosure.

The invention relates to a device for producing a tubular film comprising an outlet nozzle out of which a plastic melt can be guided and formed into a tubular film, and a cooling means arranged downstream of the outlet nozzle in the transport direction. The tubular film can be cooled with said cooling means. This is preferably achieved by applying a fluid to the outside wall and/or inside wall of the tubular film, which fluid emerges, in particular, from apertures of the cooling means, the apertures being oriented toward the wall of the tubular film so that the fluid is directed onto the wall of the tubular film. The fluid preferably has a temperature that is lower than the temperature of the film bubble, when said film bubble is in the area of the cooling means. The fluid may have room temperature, for example. Preferably, air is used as the fluid, however, a liquid such as water may also be provided. Furthermore, the device has at least one detection means for observing the tubular film in an observation area. The invention is characterized in that the observation area is arranged between the outlet nozzle and the cooling means. The entire area between the outlet nozzle and the cooling means is the maximum observation area. However, viewed in the transport direction of the tubular film, the observation area may also be smaller than the maximum observation area. The cooling means is understood to mean the first cooling means which the tubular film passes after leaving the outlet nozzle. Said first cooling means may, in particular, consist of several individual elements and may be arranged outside and/or inside of the tubular film and may be annular or circular. An external cooling ring thus circumscribes the tubular film. The tubular film and the external cooling ring are arranged concentrically to one another. In particular an external cooling ring may also comprise a plurality of individual rings positioned one behind the other as viewed in the transport direction.

The detection means comprises a least one detector with which the electromagnetic radiation emitted by the blown film can be detected or is detected. The electromagnetic radiation can be in the so-called infrared range, where the wavelength is between 780 nm and 1 mm, but also in the range that is visible to humans (wave length between 380 nm and 780 nm) or in the high-energy range (UV radiation, wavelength below 380 nm). Typically, the infrared radiation is radiation that occurs in the blown film itself, which is attributable to thermal radiation. The visible and high-energy radiation is typically generated in a light source provided for this purpose and which is reflected or transmitted by the film bubble. By using radiation at different wavelengths, different properties of the film bubble can be examined. Visible radiation can be used, for example, to make defects of the film bubble visible such as stripes or specks. The radiation in the infrared range originates at least partially from the thermal radiation of the film bubble. The wave length and/or the intensity of said radiation is therefore an indicator of the temperature of the film bubble.

As the detection means, for example, at least one of the following camera types may be provided: color camera, laser scanner camera, LIDAR (three-dimensional laser scanning), 3D camera (such as stereo cameras, triangulation system, interferometric measuring system, time-of-flight camera, light field camera). Of course, a plurality of detection means may also be provided with all detection means comprising the same camera type, or two or more different camera types being provided.

The detection means can now be used to observe the tubular film at a high sampling rate or even continuously. In particular the lateral outer edges of the tubular film are detectable. If the shape of the tubular film deviates from the normal shape during operation, an evaluation and control means, which compares the observed shape of the tubular film with the normal shape or the target shape stored in the memory, can issue a warning signal to the operator and/or bring the actual shape of the tubular film back to the normal or target shape by influencing production parameters. Normal shape means the shape which the tubular film has during stationary operation. If, in fact, a camera or a system is provided with which the tubular film can be viewed in three dimensions, then a shape change of the tubular film can not only be viewed transversely to the viewing direction of the detection means, but also in or against the viewing direction. This improves the detection of shape deviations.

The detection means can alternatively or additionally be used to detect the temperature of the tubular film. The temperature results from the intensity of the recorded radiation of the tubular film in the wavelength range or in the wavelength ranges that can be detected with the detection means. One or more calibration elements may be provided, each of which can be brought to a specific temperature, in particular, to different temperatures in the case of several calibration elements. If the detection means now only detects one calibration element, the measured temperature value measured by the detection means can be adapted to the actual temperature of the respective calibration element. This measured value modification can now be retained for the subsequent measurements of the tubular film. The calibration element may be the film bubble itself if its absolute temperature is known.

In this way, it is possible to detect a deviation in the tube shape and react to it before such a deviation leads to a melt breakage or tubular film breakage. A timely reaction therefore means that such a breakage can be avoided and the tubular film can be kept consistent over a long period of time and production can continue uninterrupted. A change in the shape of the tubular film can, for example, be caused by a change in the ambient temperature. It is also possible to detect changes in the temperature of the film bubble. The ambient temperature can also have an influence here. Changes of the temperature and/or the tube shape can, in particular, occur with a product changeover from a current product application to a subsequent product application, whereby the tubular film and/or film bubble remains in place even during a product changeover. Detection of the tube shape is of particular importance here, as the consistency of the film bubble can also be ensured during the product changeover.

The shape of the tube can be observed over the entire observation range of the detection means. However, it is also advantageous to determine the shape of the tube, in particular the diameter of the tubular film, directly after it leaves the outlet nozzle. It is further advantageous to determine the shape of the tube, in particular, the diameter of the tubular film, directly prior to passing the cooling means. In a further embodiment, the diameter of the tubular film can be compared with the inside diameter of the cooling ring, i.e. the diameter of the free space inside the cooling ring, by means of the evaluation and control means. If this results in a difference above a threshold value, i.e., a distance between the outer wall of the tubular film and the inner diameter of the cooling ring above the threshold value, the diameter of the tubular film can be controlled so that the difference is below the threshold value. This achieves improved cooling of the tubular film.

In a further embodiment of the invention, at least one cooling ring may be provided which comprises suction means for sucking the tubular film in the direction of the inner wall of the cooling ring. The detection means can now be used to measure the diameter of the tubular film and compare it with the area of influence of the suction means on the tubular film. If, in this case too, the diameter indicates that the distance between the tubular film and the suction means is too great, the diameter of the tubular film can be adjusted by means of the evaluation and control means so that it enters the area of influence of the suction means and is sucked in. In this case, too, an improved cooling of the tubular film is achieved.

In particular, as described, an evaluation and control means is provided with which the actual and the target shape of the tubular film can be detected. Furthermore, the evaluation and control means is preferably configured to compare the actual shape of the tubular film, in particular its outer diameter, with geometric data of the cooling means, in particular, with the inner diameter of a cooling ring surrounding the tubular film. In particular, it is intended that the diameter of the tubular film is smaller than or equal to the passage diameter of a cooling ring.

A comparison of successively detected shapes of the film bubble by the evaluation and control means is also advantageous, as the development of this shape over time can be analyzed and changes detected. A comparison with a target shape of the film bubble is not necessary in this case. For example, a strong pumping of the film, i.e., a periodic increase and/or decrease in the shape of the tubular film, in particular its diameter, can be detected. The evaluation and control means can carry out suitable countermeasures such as the material throughput or the draw-off speed. Fluttering of the tubular film, i.e., small but high-frequency changes in diameter and/or periodic local shifts of the center point of the tubular film relative to the nominal line of symmetry, can also be detected. Countermeasures can be taken in this case as well. The line of symmetry can be formed from the imaginary connection of the center point of the circular outlet nozzle and the center point of another circular or annular element, for example the annular cooling element. Of course, a deviation of the axis of symmetry of the tubular film from the line of symmetry can also be detected. Again, suitable countermeasures are conceivable.

A comparison of the target and actual shape or the comparison of successively detected shapes of the film bubble can also result in a drop in a widening of the film bubble, i.e., a movement of the widening against the transport direction of the film bubble, being detected. In this case, the evaluation and control means can also initiate countermeasures.

Furthermore, by observing the tubular film, it is possible to detect a bubble breakage and/or holes or other openings in the wall of the tubular film. Here too, measures can be initiated by the evaluation and control means. In addition to the immediate output of an alarm, this can be the immediate interruption of further melt discharge from the outlet nozzle, in particular, in the event of a bubble breakage.

In an advantageous embodiment of the invention, a displacement means is provided with which the cooling means can be displaced relative to the outlet nozzle in or against the transport direction of the tubular film. This displacement means may, for example, comprise threaded rods which engage in screws attached to the cooling means. Rotation of the threaded rods results in a linear movement of the cooling means. The threaded rods can be supported on the die. Such a displacement means can be used to enlarge the observation area to make it easier to determine deviations in the shape of the tubular film.

It is also advantageous if the detection means can be moved in or against the transport direction relative to the outlet nozzle using a positioning device. The positioning device may be designed in a similar way to the displacement means of the cooling means. With this positioning device, the detection means can be positioned on a plane of the tubular film in which the greatest effect can be expected if there are deviations in the shape of the tubular film. This makes it possible to react to such a deviation at a very early stage.

In an advantageous embodiment of the invention, it is provided that the detection means is arranged on the cooling means, in particular, on the underside of the cooling means. It is preferable that the cooling means is a cooling ring surrounding the tubular film. Such an arrangement on the cooling means eliminates the need to set up the detection means separately such as with a tripod or other support elements. In particular, if the cooling means is arranged so as to be displaceable, the described arrangement of the detection means on the cooling means also makes a means for positioning the detection means unnecessary in many cases.

It is also advantageous if the detection means, which is, in particular, arranged on the cooling means, is angle- and/or tilt- and/or height-adjustable relative to said cooling means by means of an adjustment means. Height adjustability here means the adjustment in or against the transport direction of the tubular film. The aim of this measure is to be able to change the observation area.

It is also preferable for the observation area to be arranged in the second half of the distance between the outlet nozzle and the cooling means, as viewed in the transport direction of the tubular film. The greatest effect of the expected deviations can usually be observed in this area, so that the deviations can be better detected here.

Furthermore, it is advantageous for the observation area to substantially extent across the entire width of the tubular film, as viewed transverse to the transport direction of the tubular film. The term “across the entire width” includes that, due to the viewing angle of the detection means, the tubular film cannot be detected with its full diameter, but appears with a reduced width. However, since the described deviations often occur rotationally symmetrically, this does not result in any relevant limitations.

In a further embodiment of the invention, at least one second detection means is provided, which is arranged downstream of the cooling means. Said second detection means can also be used to observe the tubular film, but downstream of the cooling means. Said second detection means may also be configured in the same way as the first detection means with regard to the detectable wavelengths of electromagnetic radiation, the structure, the determination of the shape of the film bubble and other properties already described. Said second detection means may also be connected to the evaluation and control means already described, with which the detection results of the second detection means can be evaluated.

It is advantageous that the calibration of the first and second detection means are matched to each other. For example, if the first detection means is calibrated, in particular with regard to temperature determination, the second detection means can be calibrated to the first detection means.

The shape of the film bubble determined by the second detection means can be correlated with the shape determined by the first detection means. Thus, it is possible to determine the diameter or shape of the film bubble within the cooling means by interpolating the shapes, for example. At this location, the film bubble cannot be determined directly by one of the detection means.

The data obtained by the first and second detection means can be combined for different purposes by means of the evaluation and control means. For example, parameters such as the flutter value (i.e., the periodic change in the shape over time), parameters of the shape and temperatures can be combined to form common metrics such as the total flutter value, a composite shape and temperature characteristics. Stability metrics can also be exchanged and/or compared between the detection systems. The evaluation and control means can fulfill this purpose. For example, the probability of a bubble breakage can be determined. Calculations can also be made from the flutter value, the homogeneity of the temperatures, the temporal constancy of the shape, a possible asymmetry of the tubular film and/or the diameter of the film bubble in the vicinity or in the cooling ring. These calculations can form a basis for calculating the probability of a bubble breakage. This probability calculation can in turn serve as a basis for controlling the machine parameters to reduce the probability of a bubble breakage. The probability of a bubble breakage can also be indicated to a machine operator via a display device. This can take the form of a traffic light, for example, which can display a green, a yellow and a red light to make the probability clear.

Another aspect, which also achieves the object, relates to a method for producing a tubular film in which
out of an outlet nozzle of a die;
a plastic melt is guided in a transport direction and formed into a tubular film;
the tubular film is cooled with a cooling means arranged downstream of the outlet nozzle in the transport direction;
the tubular film is observed in an observation area with a detection means.

The method according to the invention is characterized in that the observation area is arranged between the outlet nozzle and the cooling means.

The same advantages can thus be achieved which have already been described above in connection with the observation method according to the invention.

Further advantages, features and details of the invention are shown in the following description, in which various exemplary embodiments are explained in detail with reference to the figures. The features mentioned in the claims and in the description can each be essential to the invention individually or in any combination of features mentioned. Within the scope of the entire disclosure, features and details that are described in connection with the device according to the invention naturally also apply in connection with the method according to the invention and vice versa, so that reference is or can always be made reciprocally to the individual aspects of the invention with regard to the disclosure. The individual figures show:

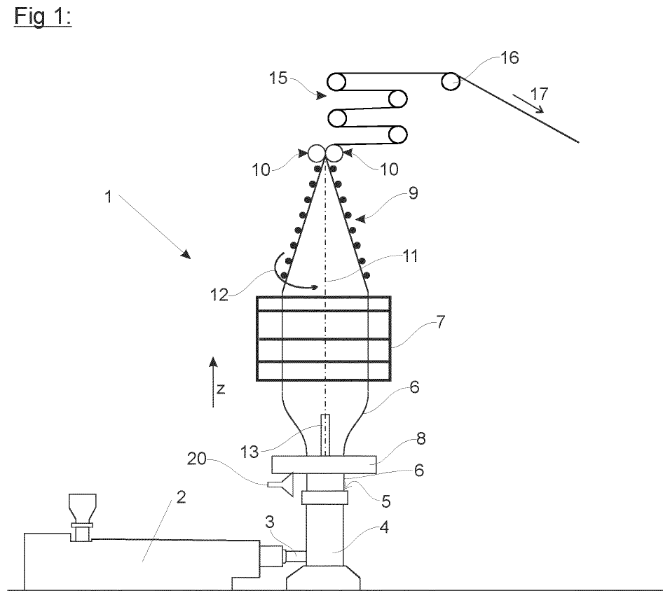

FIG. 1: a side view of a blow film line according to the invention

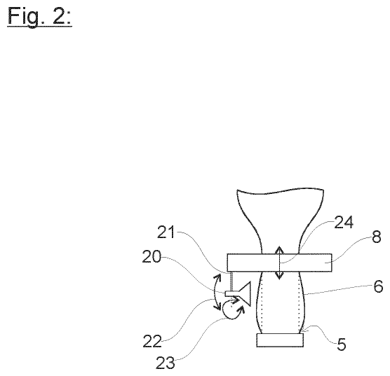

FIG. 2: section of FIG. 1

FIG. 1 shows a device 1 for manufacturing a tubular film, namely a blow film line 1 which firstly comprises at least one extruder 2 with which plastics material present in granular form, for example, can be plasticized. The plastic melt produced in this way is fed via a line 3 to a die head 4, from which this melt is transformed into a film bubble 6, so that this melt stream can be drawn out of an annular nozzle 5, which is not visible in this figure, in the draw-off direction z. Now there is a film bubble 6 that has not yet solidified. Said film bubble is inflated in the tube forming zone from the inside by a slight overpressure so that it has a larger diameter inside the calibration means 7. For this purpose, an air supply means 13 is provided, which is located within the annular nozzle 5 and extends partially in the direction of transport. Said air supply means is supplied with air through the extrusion tool.

The film bubble solidifies by cooling, with part of the heat of the film bubble being given off to the environment, in particular by a cooling means 8, which is often also referred to as a cooling ring because of its ring-like configuration enclosing the tubular film.

After passing through the calibrating device 7, the film bubble 6 enters the effective working region of a laying-flat device 9, in which the circular tubular film is transformed into an elliptical cross-section with increasing eccentricity until it finally forms a double-layer plastic film, which is joined together at its sides, in the region of influence of the draw-off device, which comprises, in particular, two draw-off rollers 10.

The laying-flat device is rotatably arranged, wherein the axis of rotation is substantially flush with the tube axis or axis of symmetry 11, which is indicated in FIG. 1 as a dot-dashed line. The rotatability of the laying-flat device is indicated with the arrow 12.

FIG. 1 furthermore shows a reversing means 15, the task of which is to guide the laid-flat tubular film from the laying-flat device to the fixed roller 16 without damages occurring.

The arrow 17 indicates that, after passing through the reversing device 15, said tubular film is guided to further processing, which is not specified in detail here.

As viewed in the transport direction z, at least one detection means 20 is arranged between the annular nozzle 5 and cooling means 8, with which detection means at least partial surface areas of the surface of the film bubble 6 can be detected. The detection means 20 is arranged preferably outside of the film bubble 6, but directed toward it. The detection means 20 may be directly or indirectly fasten to any component of the blow film line 1. It is, however, also conceivable to setup the detection means 20 independently from the blow film line 1 on its own stand, for example a tripod, within the production facility.

FIG. 2 now shows a section of FIG. 1, substantially showing the film bubble 6 in the tube formation zone and the annular nozzle 5, the cooling means 8, the calibration means 7 and the detection means 20.

The detection means 20 comprises, in particular, at least 32 detection elements so that a sufficient number of points on the circumference of the tubular film can be detected simultaneously. However, the detector preferably has at least a so-called HD resolution, i.e., at least 720 detection elements per side direction. A detector preferably has a refresh rate of at least 3 Hz, preferably at least 9 Hz, which means that at least three and preferably at least nine detections can be carried out per second with each detection element. Each of the detection elements is capable of measuring the associated intensity in one or more wavelength ranges. In particular in the infrared radiation range, a temperature of the tubular film can be assigned to the radiation intensity at a specific wavelength.

As shown, a detection means 20 may be provided. However, to be able to scan a larger circumferential area, it is advantageous to design the detection means 20 to be movable around in the circumferential direction of the film bubble.

Alternatively or additionally, at least one second detection means may be provided, with which surface areas of the surface of the film bubble 6 can be scanned which at least partially cannot be scanned by the first detection means 20.

FIG. 2 shows the area between the annular nozzle 5 and the cooling means 8. It is shown that the detection means is preferably but not mandatorily arranged on the cooling means by means of a mount 21. It is possible that the detection means is rotatable about a vertical axis in the direction of the double-headed arrow 22 and/or about a horizontal axis 21 to make the observation area variable.

The double-headed arrow 24 indicates that the cooling means 8 is displaceable in and against the transport direction z of the tubular film.

FIG. 2 also shows, by way of example, that the shape of the film bubble 6 deviates in a barrel-shaped manner from the exemplary ideal cylindrical shape (represented as broken lines). Such a deviation can be recognized by means of an evaluation and control means (not shown). The evaluation and control means can, for example, derive and/or carry out measures to reduce the deviation.

List of reference signs

| | |
|---|---|
| 1 | Device for manufacturing a tubular film |
| 2 | Extruder |
| 3 | Line |
| 4 | Nozzle head |
| 5 | Annular nozzle |
| 6 | Film bubble |
| 7 | Calibration device |
| 8 | Cooling means |
| 9 | Laying-flat device |
| 10 | Draw-off rollers |
| 11 | Tube axis or axis of symmetry |
| 12 | Arrow for indicating the rotatability of the laying-flat device |
| 13 | Air supply means |
| 14 | |
| 15 | Reversing mechanism |
| 16 | Stationary roller |
| 17 | Arrow |
| 18 | |
| 19 | |
| 20 | Detection means |
| 21 | Mount |
| 22 | Double arrow |
| 23 | |
| 24 | Double arrow |

1. A device for producing a tubular film comprising
an outlet nozzle of a die from which a plastic melt can be guided out in a transport direction and can be formed into a tubular film;
a cooling means arranged downstream of the outlet nozzle in the transport direction;
at least one detection means for observing the tubular film in an observation area,
characterized in that
the observation area is arranged between the outlet nozzle and the cooling means.

2. The device according to claim 1,
characterized in that
at least one displacement means is provided with which the cooling means is displaceable relative to the outlet nozzle in or against the transport direction.

3. The device according to claim 1,
characterized in that
a positioning means is provided with which the detection means is displaceable in or against the transport direction relative to the outlet nozzle.

4. The device according to claim 1,
characterized in that
the detection means is arranged on the cooling means, in particular, on the underside of the cooling means.

5. The device according to claim 1,
characterized in that
the detection means is angle- and/or tilt-adjustable relative to the cooling means with an adjustment means to be able to change the observation area.

6. The device according to claim 1,
characterized in that
the observation area is arranged in the second half of the distance between the outlet nozzle and the cooling means, as viewed in the transport direction.

7. The device according to claim 1,
characterized in that
the observation area extends substantially across the entire width of the tubular film, as viewed transverse to the transport direction.

8. A method for producing a tubular film in which
out of an outlet nozzle of a die;
a plastic melt is guided in a transport direction and formed into a tubular film;
the tubular film is cooled with a cooling means arranged downstream of the outlet nozzle in the transport direction;
the tubular film is observed in an observation area with a detection means,
characterized in that
the observation area is arranged between the outlet nozzle and the cooling means.
